(19) United States
(12) Patent Application Publication
(10) Pub. No.: US 2022/0020006 A1
(43) Pub. Date: Jan. 20, 2022

(54) PASSIVE RESOURCE INSTANT TRANSLATION SYSTEM

(71) Applicant: Bank of America Corporation, Charlotte, NC (US)

(72) Inventors: Charles Jason Burrell, Middleburg, FL (US); Justin Riley duPont, Charlotte, NC (US); Michael Robert Hasslinger, Huntersville, NC (US); John Allen Sellers, Kennett Square, PA (US); Tony England, Tega Cay, SC (US); Christina Ann Lillie, Saline, MI (US)

(73) Assignee: Bank of America Corporation, Charlotte, NC (US)

(21) Appl. No.: 16/933,170

(22) Filed: Jul. 20, 2020

(51) Int. Cl. G06Q 20/38; G06Q 20/22; G06Q 20/36; G06Q 30/02

(52) U.S. Cl. CPC G06Q 20/387; G06Q 20/227; G06Q 30/0215; G06Q 30/0233; G06Q 20/3672

(57) ABSTRACT

Embodiments of the invention are directed to a system, method, or computer program product for passive resource instant translation. The invention receives input from a user via a communicable linkage between the user and the user's passive resource collection account. Passive resources are instantly translated to resources ready for use according to a passive resource to active resource translation ratio. The converted passive resources are stored in a converted passive resource account. The invention may then identify a user request for transfer of active resources and prompt the user to select a resource account to fulfill the user request. The invention may then release active resources based on user request and input.

### BACKGROUND

During typical resource transfers, users may accumulate passive resources for distributing resources to various entities. Passive resources are typically accrued in a passive resource account. Users typically manually initiate translation of accrued passive resources into active resources ready for distribution. However, translation of passive resources currently requires user intervention. As such, a need exists for a system that allows a user to opt in for instant translation of passive resources, instantly translate all passive resources to resources ready for distribution, and store converted passive resources in an account ready for user resource distribution.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later. Embodiments of the present invention address these and/or other needs by providing an innovative system, method and computer program product for instant translation of passive resources to resources that are ready for distribution.

In some embodiments, the present invention allows for instant translation of passive resources acquired from resource distributions to various entities. For example, when a user distributes resources to a restaurant or retailer, the user will acquire passive resources for distributing resources to those entities. The passive resources collected by the user will accumulate in a passive resource bank. Typically, the passive resources are illustrated as discounts or other benefits, such as a lower interest rate, airline miles, or the like. The user may manually apply these passive resources as discounts when the user distributes resources to other entities. Most often, a user will manually translate these passive resources into active resources ready for distribution. This invention prompts a user to opt in for instant translation of passive resources and instantly translates accumulated passive resources into resources ready for distribution. Converted passive resources will be stored in a converted passive resource account that a user can select to distribute resources from.

Embodiments of the invention relate to systems, methods, and computer program products for passive resource instant translation, the invention comprises: receiving signals from a user passive resource collection account; generating a communicable linkage with smart device systems associated with a user and receiving signals via the communicable linkage, wherein the signals provide real-time updates when the user communicates and transfers resources to an entity, and collects passive resources in the passive resource collection account; applying a passive resource to active resource translation ratio to instantly translate received passive resources to active resources ready for use; storing converted resources in a converted passive resource account for user's use; identifying user request for transfer of active resources from the converted passive resource account; prompting the user to select a resource account for user request; and releasing active resources based on user request and input.

In some embodiments, the translation ratio may differ based on status or frequency of resource transfer between the user, financial institution, and entity.

In some embodiments, the translation ratio may differ based on an entity's line of business.

In some embodiments, prompting the user to select a resource account to fulfill the user request is further provided by a graphical user interface application.

In some embodiments, the application may present the user with various resource accounts to fulfill the user resource transfer request.

In some embodiments, the application further comprises a communication linkage generator to transmit user input to the financial institution or entity.

In some embodiments, the user may opt in for instant translation of earned passive resources to active resources ready for use.

In some embodiments, the user may select multiple resource accounts to distribute resources from, wherein the distribution amount from each resource account may be customized.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a passive resource instant translation system environment, in accordance with one embodiment of the present invention;

FIG. 2 provides a high level process flow illustrating translation of passive resources and storage of converted resources in a converted passive resource account, in accordance with one embodiment of the present invention; and

FIG. 3 provides a detailed process map illustrating user initiation of resource distribution and user selection of resource distribution accounts, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to an individual acquiring the passive resources from various resource distributions. In some embodiments, identities of an individual may include online handles, usernames, aliases, family names, maiden names, nicknames, or the like. For purposes of this invention, the term “user” and “user” may be used interchangeably. Furthermore, as used herein the term “user device” or “mobile device” may refer to mobile phones, personal computing devices, tablet computers, wearable devices, and/or any portable electronic device capable of receiving and/or storing data therein.

The terms “financial institution” and “financial entity” may be used to include any organization that processes financial transactions including, but not limited to, banks, credit unions, savings and loan associations, investment companies, stock brokerages, management firms, insurance companies and the like. In specific embodiments of the invention, use of the term “bank” is limited to a financial entity in which account-bearing customers conduct financial transactions, such as account deposits, withdrawals, transfers, and the like.

An “entity” as used herein may refer to any organization with which a user may interact and distribute resources to. An entity may refer to an individual or acquaintance of the user's, a business, company, or other organization that may participate with a financial institution for users with passive resources after the user distributes resources to the entity.

A “passive resource” as used herein may refer to points or rewards accrued by a user for distributing resources to an entity. Passive resources may be accrued in a passive resource collection account. Users may use passive resources for discounts when a user distributes resources to an entity, or the user may manually request to convert the passive resources into active resources, or resources ready for use. The manually converted passive resources are typically processed and transferred to the user's primary resource account.

A “translation ratio” as used herein may include a rate for converting a passive resource to an active resource, or for an active resource to a passive resource conversion. A translation ratio may be determined by an entity or a financial institution and may differ based on status or frequency of resource transfer between the user, financial institution, and entity. The translation ratio may also differ based on the entity's line of business.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “resource distribution” refers to any transaction or communication between a user and a financial institution, or entity to which a user distributes resources for the purchasing of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

In some embodiments, the invention allows for the instant translation of passive resources accrued by the user, based on the relationship between the entity, user and financial institution. For example, a user may earn passive resources by distributing resources to a restaurant or retailer. The passive resources will be accrued in a passive resource collection account. A user may earn more passive resources based on the entity's relationship with the financial institution. The entity's relationship with the financial institution may be determined based on the number of years a financial institution has partnered with an entity. The entity's relationship with the financial institution may also be determined by how often the user distributes resources to the entity. This invention allows a user to opt in for instant translation of accrued passive resources. Upon the user opting in, the invention will instantly translate all accrued passive resources contained in the passive resource collection account. The passive resources will instantly be converted to active resources, based on a translation ratio established by the entity and financial institution. Subsequently, the converted passive resources will be stored in a converted passive resource account, where the resources are ready for distribution. Furthermore, the user may select the converted passive resource account, among other available resource accounts, to distribute resources from. For example, the user may select the converted passive resource account to distribute resources to an entity, to pay down a loan, or to a friend of the user. Instead of changing an amortization rate or translating the passive resources into discounts for subsequent resource distributions, the system instantly translates all passive resource into resources ready for distribution. The invention may also allow the user to divide the total resource distribution among multiple resource accounts. For example, the user may select the converted passive resource account and another resource account to distribute resources evenly from.

In some embodiments, the smart devices may be associated with the user and the user's resource accounts that generate a communicable linkage to provide real-time updates when the user communicates and transfers resources to an entity, or when there are changes in the balance of the user's passive resource collection account. This communicable linkage allows for user accounts to be monitored for increases, decreases, user patterns of passive resource use, and the like.

In some embodiments, user requests for translation may further be provided by a graphical user interface (GUI) application. The application may present the user with various resource accounts to fulfill user resource transfer requests. Further, the application may include a communication linkage generator to transmit user input and communications to the financial institution or entity, to allow for resource distribution.

Embodiments of the present invention address the above needs and/or achieve other advantages by providing apparatuses (e.g., a system, computer program product and/or other devices) and methods for passive resource instant translation.

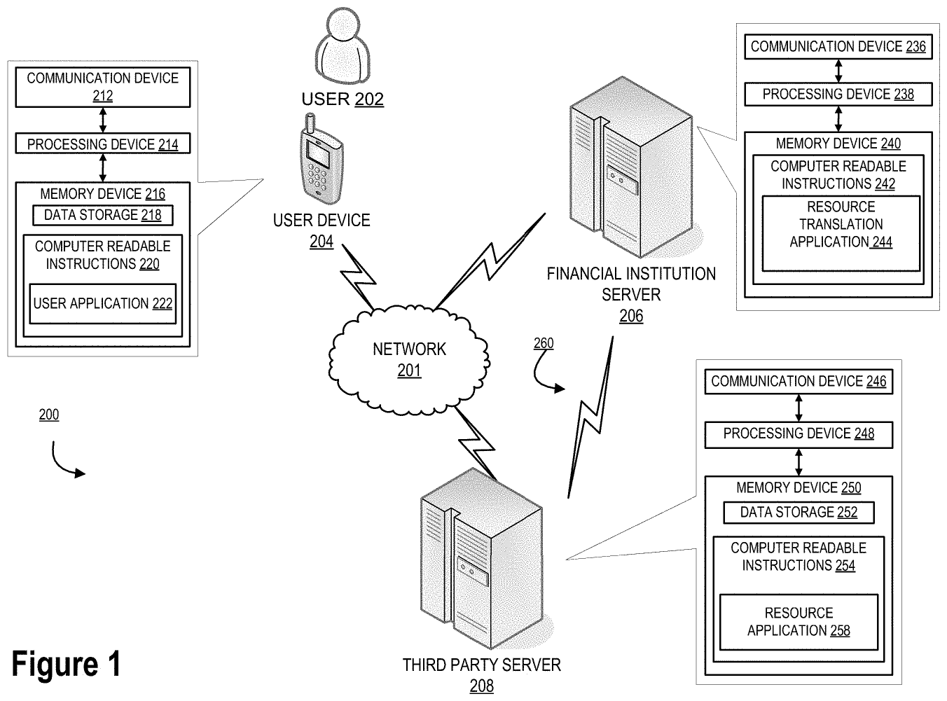

FIG. 1 illustrates a passive resource instant translation system environment 200, in accordance with one embodiment of the present invention. FIG. 1 provides the system environment 200 for which the distributive network system with specialized data feeds. FIG. 1 provides a unique system that includes specialized servers and system communicably linked across a distributive network of nodes required to perform the functions described herein.

As illustrated in FIG. 1, the financial institution server 206 is operatively coupled, via a network 201 to the user device 204, and third party server 208. In this way, the financial institution server 206 can send information to and receive information from the user device 204 and third party server 208. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual associated with the financial institution. In other embodiments, the user 202 is an entity. In some embodiments, the user 202 has a user device, such as a mobile phone, tablet, computer, or the like. FIG. 1 also illustrates a user device 204. The user device 204 may be, for example, a desktop personal computer, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to financial institution server 206 and the third party server 208. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the financial institution server 206.

As further illustrated in FIG. 1, the financial institution server 206 generally comprises a communication device 236, a processing device 238, and a memory device 240. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 238 is operatively coupled to the communication device 236 and the memory device 240. The processing device 238 uses the communication device 236 to communicate with the network 201 and other devices on the network 201, such as, but not limited to the third party server 208 and the user device 204. As such, the communication device 236 generally comprises a modem, server, or other device for communicating with other devices on the network 201.

As further illustrated in FIG. 1, the financial institution server 206 comprises computer-readable instructions 242 stored in the memory device 240, which in one embodiment includes the computer-readable instructions 242 of an institution application 244.

In one embodiment of the financial institution server 206, the memory device 240 stores a resource translation application 244. In one embodiment of the invention, the resource translation application 244 may associate with applications having computer-executable program code that applies a translation ratio to convert passive resource to active resources, or active resources to passive resources. In one embodiment, the computer-executable program code of an application associated with the resource translation application 244 may also instruct the processing device 238 to perform certain logic, data processing, and data storing functions of the application.

The processing device 238 is configured to use the communication device 236 to communicate with and ascertain data from the user 202, user device 204, and third party server 208. In the embodiment illustrated in FIG. 1 and described throughout much of this specification, the resource translation application 244 may be coded for user device 204 and third party server 208 communication for user requests for instant translation of passive resources. As such, the resource translation application 244 may receive communications from the user device 204 and the third party server 208, decrypt and standardize the received communications such that the communications are compatible with the system, and analyze the communications received to determine user request for instant translation of passive resources.

As illustrated in FIG. 1, the third party server 208 is connected to the financial institution server 206 and user device 204. The third party server 208 has the same or similar components as described above with respect to the user device 204 and the financial institution server 206. While only one third party server 208 is illustrated in FIG. 1, it is understood that multiple third party servers 208 may make up the system environment 200. The third party server 208 may be associated with one or more financial institutions, insurance corporations, merchants, restaurants, retailers, businesses, resource allocators and the like. As such, the user device 204 may communicate with the third party to distribute resources to the third party. The financial institution server 206 may also communicate with the third party to confirm user resource distribution. It is understood that the servers, systems, and devices described herein illustrate one embodiment of the invention. It is further understood that one or more of the servers, systems, and devices can be combined in other embodiments and still function in the same or similar way as the embodiments described herein.

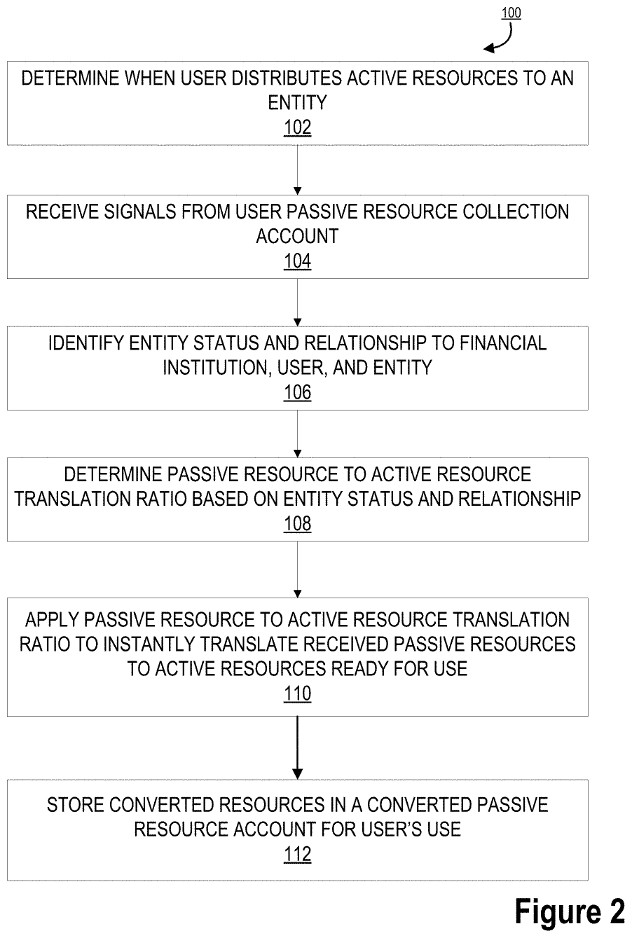

FIG. 2 illustrates a high level process implementing the passive resource instant translation process 100, in accordance with one embodiment of the present invention. As illustrated in block 102, the process 100 is initiated by the financial institution determining when the user distributes active resources to an entity, via a communicable linkage between the financial institution, third party, and user device. A third party may be a merchant, insurance company, financial institution, or any entity in which the user distributes resources or receives resources from. A communicable linkage can result from the user device sending notifications to the financial institution, or the entity sending notifications to the financial institution.

Next, as illustrated in block 104, the process 100 continues by receiving signals from the user's passive resource collection account. The signals may include signaling information in accordance with a cellular system of the wireless telephone network, signals arising from user activity within an application associated with the financial institution, or notifications from the application associated with the financial institution to the financial institution about increases or decreases in the user's passive resource collection account balance. In this way, the system identifies increases or decreases in the user's passive resource collection account. Changes in the user's passive resource collection account indicates user resource distribution to a third party and user acquisition of passive resources. Once changes in the user's passive resource collection account are detected, the process 100 can identify the third party, or entity, status and the third party's relationship to the financial institution and user, as illustrated in block 106. The process 100 may identify the third party's status or relationship to the financial institution by searching a financial institution database of third parties the financial institution transacts with. The process 100 may also examine the user's transaction history and determine the frequency of the user's transactions with the third party to determine the third party's relationship to the financial institution and the user. Once passive resources are deposited into the user passive resource collection account, the process 100 will determine a passive resource to active resource translation ratio based on entity status and relationship, as illustrated in block 108.

For example, the financial institution may distribute more passive resources if a user distributes resources to a restaurant, rather than a clothing retailer. The third party relationship to the financial institution may be determined based on the third party's line of business or frequency in which the user distributes resources to that entity. As such, in order for passive resources to be deposited in the user's passive resource collection account, the third party must have a relationship to the financial institution.

Next, as illustrated in block 110, the process 100 will apply the passive resource to active resource translation ratio to instantly translate received passive resources to active resources ready for use by the user. The instant translation process may be completed via simple mathematical multiplication of the ratio to the balance in the passive resource collection account. The translation process may also be completed using more complex mathematical processes. The translation process may be effectuated via computer-executable program code that instructs the resource translation application 244 or financial institution server 206 to compute the instant translation calculation. The process 100 is finalized when the converted resources are stored in a converted passive resource account for user's use, as illustrated in block 112.

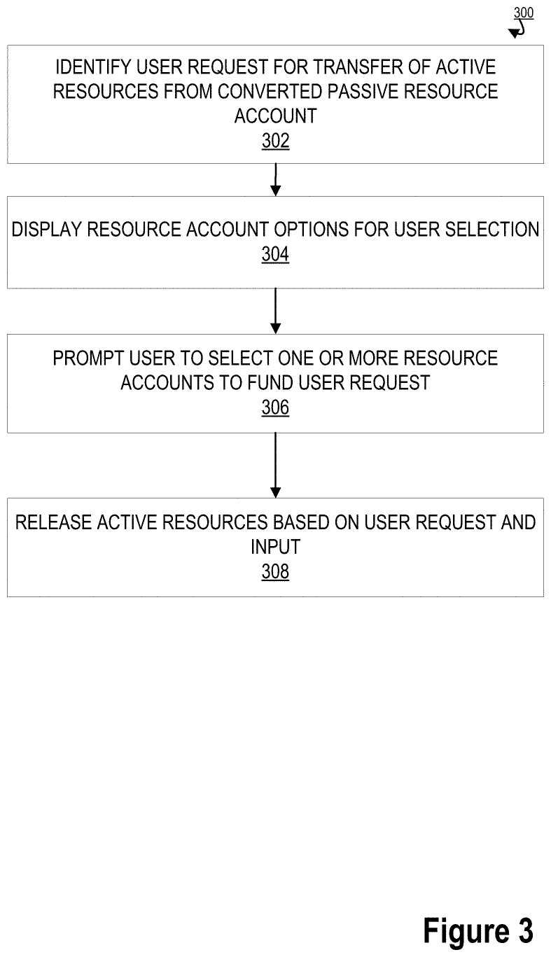

FIG. 3 provides a detailed process map illustrating the user initiation process 300 for resource distribution of converted passive resources, in accordance with one embodiment of the present invention. As illustrated in block 302, the process 300 is initiated by identifying the user request for transfer of active resources from the converted passive resource account. In some embodiments, the user request may be processed via an application associated with the financial institution or third party. The request may also be processed via a computing device associated with the user, a phone, or a mobile device. The user may transmit a request directly or through an application, online portal, internet browser, virtual private network, or other connection channel.

Next, as illustrated in block 304, the process 300 continues with a display of resource distribution account options for user selection. The display may be on an application associated with the financial institution, via text, online, and the like. The user will be prompted to select one or more resource distribution accounts to fund the user request, as illustrated in block 306. In some embodiments, the prompt may be via text, a pop-up notification on the application, or via telephone call. User selection of resource distribution accounts may also occur via a user output device (such as a user display device or a speaker), user input devices (such as a microphone, keypad, touchpad, touch screen, and the like), or a communication device. The user may select multiple resource distribution accounts and divide the total resource distribution requested amongst those accounts. The user may also designate particular amounts to distribute from each resource distribution account.

Finally, as illustrated in block 308, based on the user request in block 306, the process 300 will release active resources from the accounts the user selected.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for passive resource instant translation, the system comprising:
a memory device with computer-readable program code stored thereon;
a communication device;
a processing device operatively coupled to the memory device and the communication device, wherein the processing device is configured to execute the computer-readable program code to:
receive signals from a user passive resource collection account;
generate a communicable linkage with smart device systems associated with a user and receive signals via the communicable linkage, wherein the signals provide real-time updates when the user communicates and transfers resources to an entity, and collects passive resources in the passive resource collection account;
apply a passive resource to active resource translation ratio to instantly translate received passive resources to active resources ready for use;
store converted resources in a converted passive resource account for user's use;
identify user request for transfer of active resources from the converted passive resource account;
prompt the user to select a resource account for user request; and
release active resources based on user request and input.

2. The system of claim 1, wherein the translation ratio may differ based on status or frequency of resource transfer between user, financial institution, and entity.

3. The system of claim 1, wherein the translation ratio may differ based on entity's line of business.

4. The system of claim 1, wherein prompting the user to select a resource account to fulfill the user request is further provided by a graphical user interface application.

5. The system of claim 4, wherein the application may present the user with various resource accounts to fulfill the user resource transfer request.

6. The system of claim 4, wherein the application further comprises a communication linkage generator to transmit user input to the financial institution or entity.

7. The system of claim 1, wherein the user may opt in for instant translation of earned passive resources to active resources ready for use.

8. The system of claim 1, further comprising enabling the user to select multiple resource accounts to distribute resources from, wherein the distribution amount from each resource account may be customized.

9. The system of claim 1, wherein the user is an individual with one or more resource accounts at a financial institution.

10. A computer program product for real-time allocated resource release at a project stage, the computer program product comprising at least one non-transitory computer-readable medium having computer-readable program code portions embodied therein, the computer-readable program code portions comprising:
an executable portion configured for receiving signals from a user passive resource collection account;
an executable portion configured for generating a communicable linkage with smart device systems associated with a user and receiving signals via the communicable linkage, wherein the signals provide real-time updates when the user communicates and transfers resources to an entity, and collects passive resources in the passive resource collection account;
an executable portion configured for applying a passive resource to active resource translation ratio to instantly translate received passive resources to active resources ready for use;
an executable portion configured for storing converted resources in a converted passive resource account for user's use;
an executable portion configured for identifying user request for transfer of active resources from the converted passive resource account;
an executable portion configured for prompting the user to select a resource account for user request; and
an executable portion configured for releasing active resources based on user request and input.

11. The computer program product of claim 10, wherein the translation ratio may differ based on status or frequency of resource transfer between user, financial institution, and entity.

12. The computer program product of claim 10, wherein the translation ratio may differ based on entity's line of business.

13. The computer program product of claim 10, wherein prompting the user to select a resource account to fulfill the user request is further provided by a graphical user interface application.

14. The computer program product of claim 10, wherein the application may present the user with various resource accounts to fulfill the user resource transfer request.

15. The computer program product of claim 10, wherein the application further comprises a communication linkage generator to transmit user input to the financial institution or entity.

16. The computer program product of claim 10, wherein the user may opt in for instant translation of earned passive resources to active resources ready for use.

17. A computer-implemented method for real-time allocated resource release at a project stage, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving signals from a user passive resource collection account;
generating a communicable linkage with smart device systems associated with a user and receiving signals via the communicable linkage, wherein the signals provide real-time updates when the user communicates and transfers resources to an entity, and collects passive resources in the passive resource collection account;
applying a passive resource to active resource translation ratio to instantly translate received passive resources to active resources ready for use;
storing converted resources in a converted passive resource account for user's use;
identifying user request for transfer of active resources from the converted passive resource account;
prompting the user to select a resource account for user request; and
releasing active resources based on user request and input.

18. The computer-implemented method of claim 17, wherein the translation ratio may differ based on status or frequency of resource transfer between user, financial institution, and entity.

19. The computer-implemented method of claim 17, wherein prompting the user to select a resource account to fulfill the user request is further provided by a graphical user interface application.

20. The computer-implemented method of claim 17, wherein the application further comprises a communication linkage generator to transmit user input to the financial institution or entity.
